(19) United States
(12) Patent Application Publication
(10) Pub. No.: US 2003/0202111 A1
(43) Pub. Date: Oct. 30, 2003

(54) Apparatus and methods for dark level compensation in image sensors using dark pixel sensor metrics

(76) Inventor: Jaejin Park, Kyungkido (KR)

Correspondence Address: MYERS BIGEL SIBLEY & SAJOVEC, PO BOX 37428, RALEIGH, NC, 27627, US

(21) Appl. No.: 10/135,211

(22) Filed: Apr. 30, 2002

(51) Int. Cl. H04N 9/64; H04N 5/235

(52) U.S. Cl. 348/243; 348/229.1; 348/280; 348/255

(57) ABSTRACT

An image sensor comprises a plurality of pixel sensors, e.g., CMOS pixel sensors, including a plurality of dark pixels. A dark level compensation circuit that controls an offset applied to an image signal generated by a pixel sensor responsive to an aggregate dark level metric, e.g., a mean dark level, derived from dark pixel image signals produced by the dark pixel sensors. For example, the dark level compensation circuit for CMOS image sensor using a column parallel architecture may generate an offset control signal that varies an offset of a reference signal used by an analog to digital converter (ADC) circuit that converts an analog image signal from a pixel sensor to a dark level compensated digital image signal.

### FIELD OF THE INVENTION

The present invention relates to image sensors and methods of operation thereof, and more particularly, to dark level compensating image sensors and methods of operation thereof.

### BACKGROUND OF THE INVENTION

Image sensors are widely used in applications such as digital photography, scanners, machine vision systems, surveillance cameras, and the like. Although charge coupled device (CCD) image sensors have been used for such applications for a relatively long time, complementary metal oxide semiconductor (CMOS) image sensors are being increasingly used. A desirable characteristic of CMOS image sensors is that they typically can be fabricated in the same chip as peripheral circuitry, e.g., image processing circuitry, thus making “camera on a chip” and other imaging applications feasible. CMOS image sensors also may have lower fabrication cost than CCD image sensors, as they typically can be manufactured using conventional CMOS fabrication techniques.

Image sensors commonly use a “column parallel” architecture in which a plurality of pixel sensors is arranged in a rectangular array having rows and columns. Pixel sensors in respective columns are coupled to respective column data lines, and are selected row-by-row to drive the column data lines. Image signals generated on the column data lines are typically converted to digital signals by respective analog to digital converter (ADC) circuits coupled to the column data lines. A variety of different techniques may be used to generate digital values from analog image signals, such as correlated double sampling (CDS) techniques that use, for example, single-slope or successive-approximation analog to digital conversion techniques.

In operating an image sensor, it typically is desirable to establish a target “dark level” (or “black level”), i.e., a signal level that corresponds to a dark (black) scene. Image signals produced by the image sensor can be adjusted based on this dark level such that an image generated from these signals has the proper luminance for better image quality. Achieving uniform dark level compensation may be problematic.

### SUMMARY OF THE INVENTION

According to some embodiments of the present invention, a complementary metal oxide semiconductor (CMOS) image sensor comprises a CMOS pixel sensor array comprising a plurality of rows of CMOS pixel sensors, each row of CMOS pixel sensors comprising at least one dark pixel sensor. The image sensor further includes a dark level compensation circuit that controls an offset applied to an image signal generated by a CMOS pixel sensor of the CMOS pixel array responsive to an aggregate dark level metric derived from dark pixel image signals produced by the dark pixel sensors. For example, the dark level compensation circuit may determine a mean dark level from the dark pixel image signals and control the offset applied to the image signal generated by the CMOS pixel sensor responsive to the determined mean dark level.

In some embodiments of the present invention for a column parallel architecture, the CMOS pixel sensor produces an analog image signal, and the image sensor further comprises an analog-to-digital converter (ADC) circuit that converts the analog image signal produced by the CMOS pixel sensor to a digital output signal subject to an offset controlled by the offset signal. For example, the offset control signal may control an offset of a reference signal produced by a single-slope ADC circuit.

In other embodiments of the present invention, the CMOS pixel array comprises a first color pixel sensor in a first row and a second color pixel sensor in a second row, wherein the first and second color pixel sensors are coupled to the same image data line. The image sensor further comprises an ADC circuit coupled to the image data line that produces a digital output signal from an analog image signal on the image data line subject to an offset that is controlled by an offset control signal applied to the ADC circuit. The dark level compensation circuit generates respective first and second offset signals to apply for the respective first and second color pixel sensors and selectively applies the first and second offset signals to the ADC circuit.

According to other aspects of the invention, an image sensor includes a plurality of pixel sensors, e.g., CMOS or charge coupled device (CCD) sensors that produce respective analog image signals. The plurality of pixel sensors includes a plurality of dark pixel sensors. An analog to digital converter (ADC) circuit receives an analog image signal generated by a pixel sensor of the plurality of pixel sensors and produces a digital image signal therefrom subject to an offset controlled by an offset control signal. A dark level compensation circuit generates the offset control signal responsive to analog image signals produced by the dark pixels of the pixel array. For example, the dark level compensation circuit may produce the offset control signal based on an aggregate dark level metric, such as a mean dark level signal derived from the analog image signals produced by the dark pixels can be compensated for process variation, temperature variation, power supply variation and the like.

In some embodiments of the present invention, the ADC circuit comprises a ramp signal generator circuit that generates a reference ramp signal having an offset that varies responsive to the offset control circuit. The ADC circuit further includes a comparator circuit that compares the reference ramp signal to the analog image signal produced by the pixel sensor of the plurality of pixel sensors. The ADC may also include a counter circuit that produces a counter output signal, and a latch circuit that latches the counter output responsive to an output signal produced by the comparator circuit.

Related methods of operating an image sensor are also described.

### BRIEF DESCRIPTION OF THE DRAWINGS

FIG. 1 is a schematic diagram illustrating a CMOS image sensor according to embodiments of the present invention.

FIG. 2 is a schematic diagram illustrating a dark level compensation circuit according to embodiments of the present invention.

FIG. 3 is a schematic diagram illustrating a CMOS image sensor according to further embodiments of the present invention.

FIG. 4 is a schematic diagram illustrating a dark level compensation circuit according to still further embodiments of the present invention.

FIG. 5 is a schematic diagram illustrating a comparator circuit for a CDS ADC according to embodiments of the present invention.

FIG. 6 is a schematic diagram illustrating a gain and offset correction circuit for a CMOS image sensor according to further embodiments of the invention.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. It will be understood that when elements are referred to as being coupled to one another, this coupling may be direct or via one or more intervening elements.

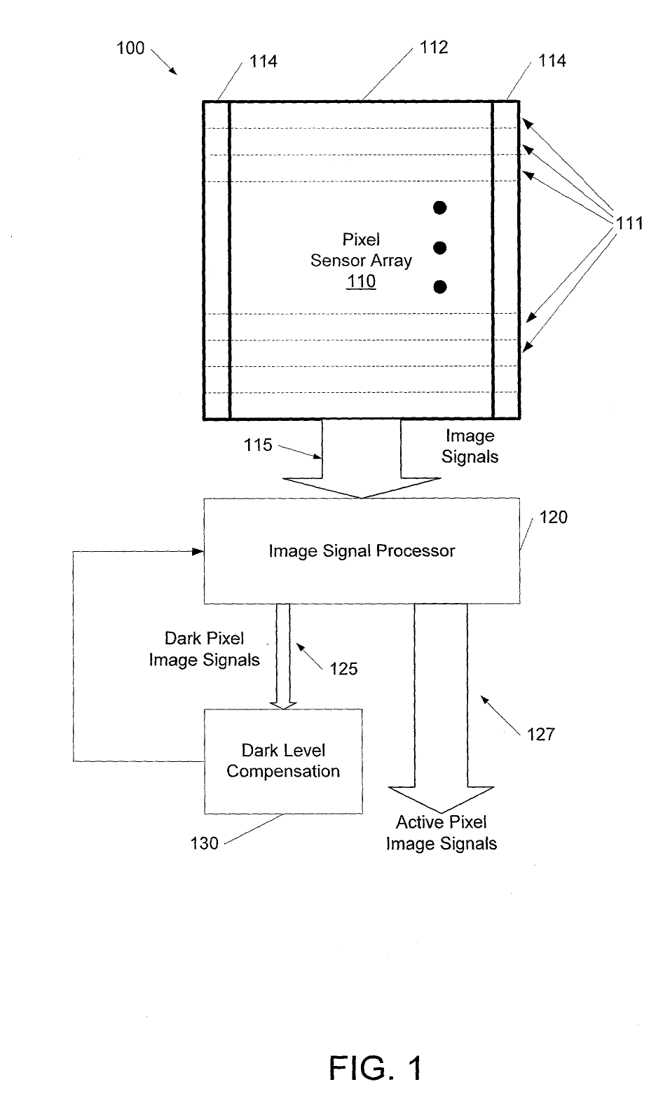

FIG. 1 illustrates a CMOS image sensor 100 according to embodiments of the present invention. The image sensor 100 includes a pixel sensor array 110 including a plurality of CMOS pixel sensors 112, 114 that are arranged in rows 111 and that generate image signals 115. The CMOS pixel sensors 112, 114 include active pixel sensors 112 that are configured to view a scene (e.g., through a lens and/or other optical component) and to generate image signals representative thereof, and dark pixel sensors 114 that are configured to view a reference dark scene (e.g., an optically black mask) and to generate image signals representative thereof. As shown, the dark pixel sensors 114 are arranged as first and second columns on opposing sides of a rectangular array of the active pixel sensors 112. However, it will be appreciated that the active pixel sensors 112 and dark pixel sensors 114 may be arranged in other ways, e.g., multiple columns of dark pixel sensors may be used in place of each of the illustrated first and second columns.

The image sensor 100 also includes an image signal processor circuit 120. The image signal processor circuit 120 is configured to receive the image signals 115 and is operative to produce dark pixel image signals 125 and active pixel image signals 127 therefrom. For example, the image signals 115 may comprise analog image signals, and the image signal processor circuit 120 may comprise an analog to digital converter (ADC) circuit that is operative to produce the dark pixel image signals 125 and/or the active pixel image signals 127 in the form of digital signals.

The image sensor 100 further includes a dark level compensation circuit 130. The dark level compensation circuit 130 is configured to receive the dark pixel image signals 125 and is operative to control an offset applied to the image signals 115 by the image signal processor circuit 120 responsively thereto. For example, the dark level compensation circuit 130 may be configured to determine an aggregate metric associated with the dark pixel image signals 125, such as a mean dark level or other average, and to control an offset applied to image signals of the image signals 115 associated with the active pixel sensors 112 and/or the dark pixel sensors 114.

It will be appreciated that the present invention may be implemented in a number of different ways. For example, the pixel sensor array 110 may comprise any of a variety of different types of image sensing cells, including charge coupled device (CCD) and complementary metal oxide semiconductor (CMOS) image sensors. The image signal processor circuit 120 may comprise, for example, an analog to digital converter (ADC) circuit that generates digital signals from analog output signals produced by such sensors. The dark level compensation circuit 130 may operate responsive to analog output signals directly produced by the sensors, or responsive to analog and/or digital signals derived from such output signals, such as digital image signals produced by an ADC circuit. The dark level compensation circuit 130 may apply an offset in an analog and/or a digital signal domain.

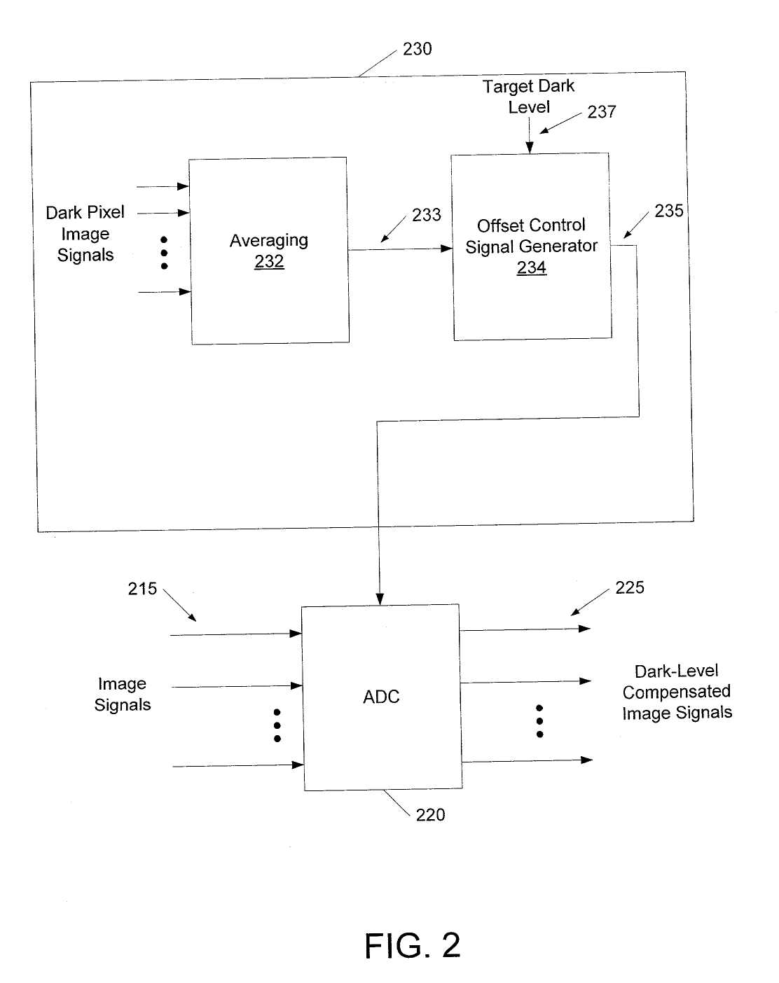

FIG. 2 illustrates a dark level compensation circuit 230 according to some embodiments of the present invention. The dark level compensation circuit 230 includes an averaging circuit 232 that is configured to receive dark pixel image signals 225 and operative to generate a mean dark level signal 233 therefrom. The mean dark level signal 233 is applied to an offset control signal generator circuit 234 that generates an offset control signal 235 based on a comparison of the mean dark level signal 233 to a target dark level signal 237. The offset control signal 235 may be applied to an analog to digital converter (ADC) circuit 220 to control an offset applied to image signals 215, thus producing dark level compensated image signals 225.

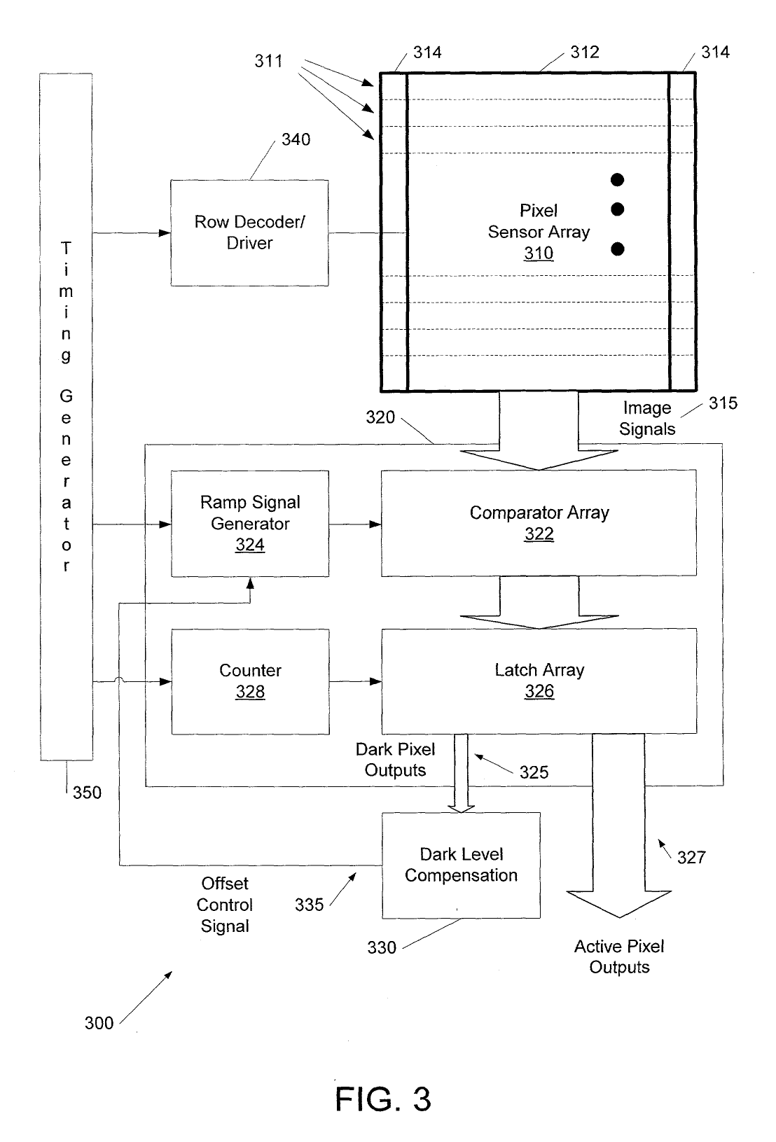

According to some aspects of the present invention, a dark level offset may be applied as part of an analog to digital conversion process that converts an analog image signal produced by a pixel sensor into a corresponding digital image signal. Referring to FIG. 3, an image sensor 300 according to further embodiments of the present invention includes a pixel sensor array 310 including a plurality of pixel sensors 312, 314 (e.g., CMOS pixel sensors) that are arranged in a plurality of rows 311 and that generate image signals 315. The pixel sensors 312, 314 include active pixel sensors 312 configured to view a scene (e.g., through a lens or other optical components) and to generate image signals representative thereof, and dark pixel sensors 314 that are configured to view a reference dark scene (e.g., an optically black mask) and to generate image signals representative thereof. As shown, the dark pixel sensors 314 are arranged as first and second columns on opposing sides of a rectangular array of the active pixel sensors 312. However, it will be appreciated that the active pixel sensors 312 and dark pixel sensors 314 may be arranged in other ways.

The image sensor 300 further includes an ADC circuit 320 including a comparator array circuit 322, a ramp signal generator circuit 324, a latch array circuit 326 and a counter circuit 328. The comparator array circuit 322 is configured to receive the image signals 315 and operative to control latching of counter values generated by counter circuit 328 by the latch array circuit 326 responsive to comparison of the image signals 315 to a ramp signal generated by the ramp signal generator circuit 324.

The image sensor 300 also includes a timing circuit 350 that controls the ramp signal generator circuit 324, the counter circuit 328 and a row decoder/driver circuit 340. The row decoder driver circuit 340 addresses the rows 311 of the CMOS pixel sensor array 310 responsive to timing information generated by the timing circuit 350. The timing circuit 350 also controls the ramp signal generator circuit 324, the counter circuit 328 and the latch array circuit 326 such that the latch array circuit 326 produces dark pixel image signals 325 corresponding to the dark pixel sensors 314 and active pixel image signals 237 corresponding to the active pixel sensors 312. The image sensor 300 further includes a dark level compensation circuit 330 that receives the dark pixel image signals 325 and that generates an offset control signal 335 applied to the ramp signal generator circuit 324.

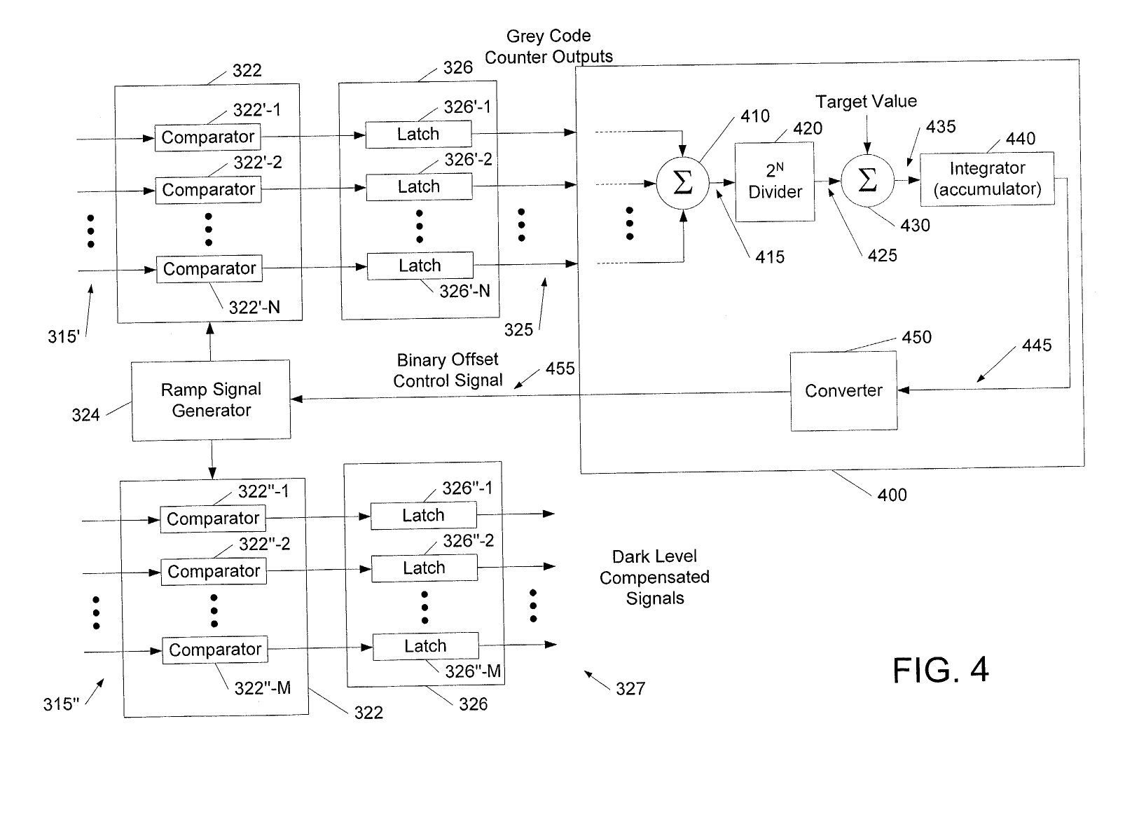

FIG. 4 illustrates a dark level compensation circuit 400 that may be used with the configuration illustrated in FIG. 3. Comparators 322′-1, 322′-2, . . . , 322′-2^{N} of the comparator array 322 receive image signals 315′ generated by the dark pixel sensors 314, and control latches 326′-1, 326′-2, . . . , 326′-2^{N} of the latch array 326 produce Grey coded digital image signals 325. The digital image signals 325′ are summed in digital summing circuit 410 and the resulting digital sum signal 415 divided by 2^{N} in a divider circuit 420 to generate a mean dark level signal 425. This mean dark level signal 425 is then subtracted from a target dark level signal 427 in a subtractor circuit 430 to generate an error signal 435. The error signal 435 is integrated in an integrator circuit 440 (e.g., a digital accumulator) to generate a compensated offset signal 445. A converter circuit 450 converts the 2's complement format error signal 445 to generate an offset control signal 455 that has a binary format. Responsive to the offset control signal 455, the ramp signal generator circuit 324 provides an offset for comparators 322″-1, 322″-2, . . . , 322″-M that are used, along with latches 326″-1, 326″-2, . . . , 326″-M to generate digital image signals 327 from image signals 315″ produced by the active pixel sensors 312.

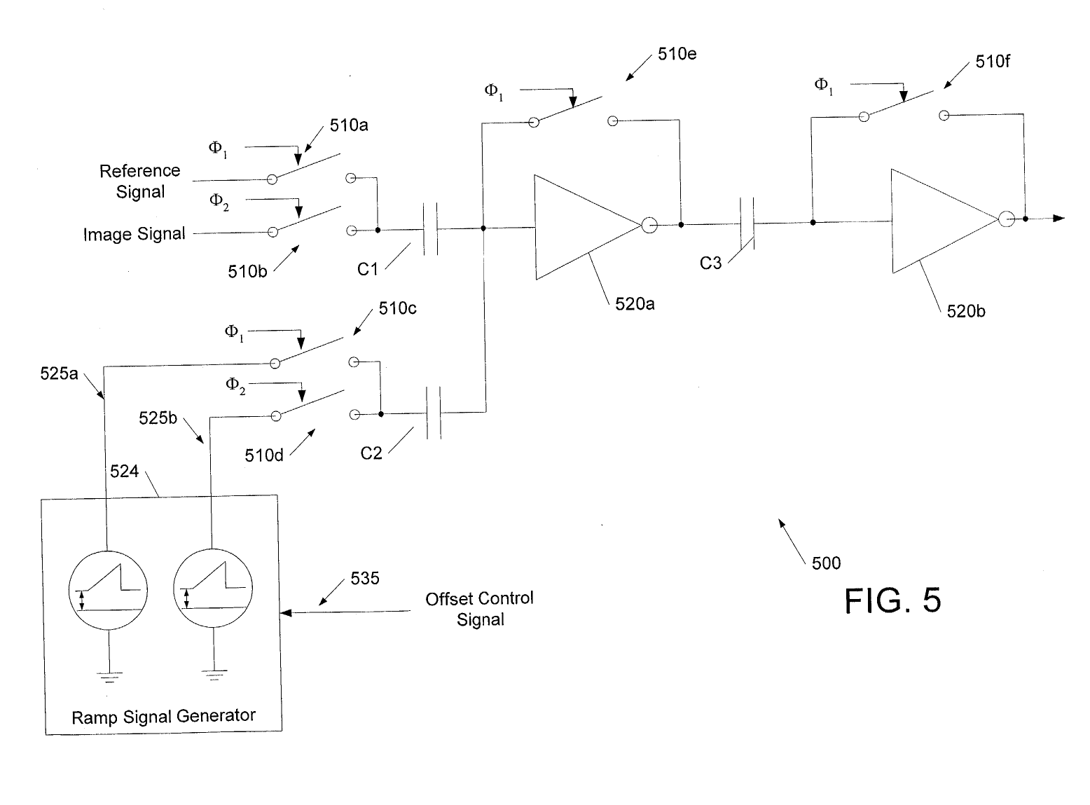

FIG. 5 illustrates an exemplary single-slope, correlated double sampling comparator circuit 500 that may be used according to embodiments of the present invention. The comparator circuit 500 includes series-connected inverters 520a, 520b and sampling capacitors C1, C2, C3, and switches 510a, 510b, 510c, 510d, 510e, 510f that are controlled by first and second clock signals Φ₁, Φ₂. The comparator circuit 500 sequentially samples reference and image signals 501, 502 produced by a CMOS pixel sensor, and compares the sampled values to first and second ramp signals 525a, 525b generated by a ramp signal generator circuit 524. Offsets of the first and second ramp signals 525a, 525b are controlled responsive to offset control signal 535.

It will be appreciated that other ways of providing a dark level-compensating offset may be used with the present invention. For example, similar approaches to the ones illustrated in FIGS. 4 and 5 may be used with types of ADC circuits other than those illustrated in FIG. 5, including, but not limited to, dual-slope and successive approximation ADC circuits. Offset compensation may also be implemented in a digital domain. For example, rather than controlling the offset of an ADC control signal as shown in FIGS. 3-5, a dark level compensation offset may be achieved by applying a digital offset value derived from dark pixel image signals to digital image signals produced by a circuit such as the ADC circuit 320 of FIG. 3.

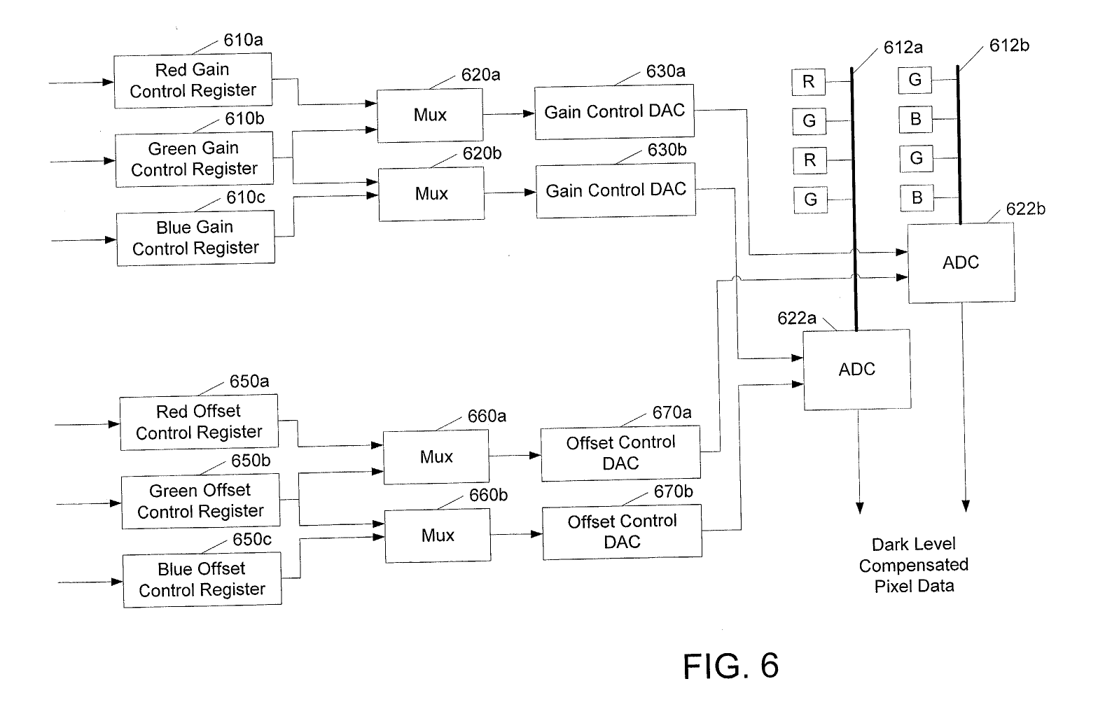

FIG. 6 illustrates an exemplary configuration for offset and gain control in an image sensor that includes red, green and blue pixel sensors R, G, B arranged in a so-called Bayer pattern in which red and green pixel sensors R, G are coupled to a first column data line 612a, and green and blue pixel sensors G, B are coupled to a second column data line 612b. Respective red, green and blue gain control registers 610a, 610b, 6120c are provided to hold gain values to be applied to respective outputs of the red, green and blue pixel sensors R, G, B. Similarly, respective red, green and blue offset control registers 610a, 610b, 6120c are provided to hold offset values to be applied to respective outputs of the red, green and blue pixel sensors R, G, B. For example, the values stored by the offset control registers 610a, 610b, 610c may be values representative of a predictive offset generated as shown, for example, in FIGS. 2 and 4.

As rows of the pixel sensors R, G, B are scanned, multiplexers 620a, 620b selectively apply the red, green and blue gain values to first and second gain control digital to analog converter (DAC) circuits 630a, 630b, which produce respective gain control signals for respective ADC circuits 622a, 622b coupled to the respective first and second column data lines 612a, 612b. For example, the gain control signals may be operative to vary a slope of a ramp reference signal used in a correlated double sampling ramp-type comparator such as that described with reference to FIG. 5. Similarly, multiplexers 620a, 620b selectively apply the red, green and blue offset values to first and second offset control DAC circuits 630a, 630b, which produce respective offset control signals for respective ADC circuits 622a, 622b coupled to the respective first and second column data lines 612a, 612b. The offset control signals may be used, for example, to control an offset of a ramp reference signal used in a correlated double sampling ramp-type comparator such as that described with reference to FIG. 5.

In the drawings and specification, there have been disclosed typical embodiments of the invention and, although specific terms are employed, they are used in a generic and descriptive sense only and not for purposes of limitation, the scope of the invention being set forth in the following claims. Although the invention has been described with reference to particular embodiments, it will be apparent to one of ordinary skill in the art that modifications of the described embodiments may be made without departing from the spirit and scope of the invention.

That which is claimed is:

1. A complementary metal oxide semiconductor (CMOS) image sensor, comprising:
a CMOS pixel sensor array comprising a plurality of rows of CMOS pixel sensors, each row of CMOS pixel sensors comprising at least one dark pixel sensor; and
a dark level compensation circuit that controls an offset applied to an image signal generated by a CMOS pixel sensor of the CMOS pixel array responsive to an aggregate dark level metric derived from dark pixel image signals produced by the dark pixel sensors.

2. An image sensor according to claim 1, wherein the dark level compensation circuit determines a mean dark level from the dark pixel image signals and controls the offset applied to the image signal generated by the CMOS pixel sensor responsive to the determined mean dark level.

3. An image sensor according to claim 2, wherein the dark level compensation circuit controls the offset applied to the image signal generated by the CMOS pixel sensor responsive to a comparison of the mean dark level to a target dark level.

4. An image sensor according to claim 3, wherein the dark level compensation circuit comprises:
an averaging circuit that processes the dark pixel image signals to generate a mean dark level signal; and
an offset control signal generator circuit, responsive to the averaging circuit, that generates an offset control signal applied to the image signal generated by the CMOS pixel sensor based on a comparison of the mean dark level signal to a target dark level signal.

5. An image sensor according to claim 4:
wherein the CMOS pixel sensor comprises a first CMOS pixel sensor that produces an analog image signal; and
wherein the image sensor further comprises a first analog-to-digital converter (ADC) circuit that converts the analog image signal produced by the first CMOS pixel sensor to a digital output signal subject to an offset controlled by the offset signal.

6. An image sensor according to claim 5, wherein the first ADC circuit comprises a correlated double sampling (CDS) ADC circuit.

7. An image sensor according to claim 6, wherein the CDS ADC circuit comprises a single-slope ADC circuit.

8. An image sensor according to claim 7, wherein the offset control signal controls an offset of a reference signal produced by the single-slope ADC circuit.

9. An image sensor according to claim 5:
wherein respective ones of the dark reference pixel sensors comprise respective second CMOS pixel sensors that generate respective analog dark level image signals;
wherein the image sensor comprises a plurality of second ADC circuits that convert respective ones of the analog dark level image signals to respective digital dark level signals;
wherein the averaging circuit comprises:
a summing circuit that sums the digital dark level signals to produce a digital dark level sum signal; and
a divider circuit that divides the digital dark level sum signal by a value derived from the number of the plurality of rows of the CMOS pixel array to produce a digital mean dark level signal;
wherein the offset control signal generator circuit comprises:
a subtraction circuit that subtracts the digital mean dark level signal from a digital target dark level signal to produce a digital error signal;
a digital accumulator circuit that compensates the digital error signal; and
a digital to analog converter (DAC) circuit that produces an analog offset control signal from the accumulated digital error signal; and
wherein the first ADC circuit converts the analog image signal produced by the first CMOS pixel sensor to the digital output signal subject to an offset controlled by the analog offset control signal.

10. An image sensor according to claim 1, wherein the CMOS pixel array comprises a first color pixel sensor in a first row and a second color pixel sensor in a second row, wherein the first and second color pixel sensors are coupled to the same image data line, wherein the image sensor further comprises an ADC circuit coupled to the image data line that produces a digital output signal from an analog image signal on the image data line subject to an offset that is controlled by an offset control signal applied to the ADC circuit, and wherein the dark level compensation circuit generates respective first and second offset signals to apply for the respective first and second color pixel sensors and selectively applies the first and second offset signals to the ADC circuit.

11. An image sensor, comprising:
a plurality of pixel sensors that produce respective analog image signals, the plurality of pixel sensors including a plurality of dark pixel sensors;
an analog to digital converter (ADC) circuit that receives an analog image signal generated by a pixel sensor of the plurality of pixel sensors and that produces a digital image signal therefrom subject to an offset controlled by an offset control signal; and
a dark level compensation circuit that generates the offset control signal responsive to analog image signals produced by the dark pixel sensors.

12. An image sensor according to claim 11, wherein the dark level compensation circuit produces the offset control signal based on an aggregate dark level metric derived from the analog image signals produced by the dark pixel sensors.

13. An image sensor according to claim 11:
wherein the ADC circuit produces digital dark pixel image signals from the analog image signals produced by the dark pixel sensors; and
wherein the dark level compensation circuit generates the offset control signal from the digital dark pixel image signals.

14. An image sensor according to claim 13, wherein the dark level compensation circuit comprises:
an averaging circuit that generates a mean dark level signal from the digital dark pixel image signals; and
an offset signal generator circuit that generates the offset control signal based on a comparison of the mean dark level signal to a target dark level signal.

15. An image sensor according to claim 11, wherein the ADC circuit comprises:
a ramp signal generator circuit that generates a reference ramp signal having an offset that varies responsive to the offset control circuit; and
a comparator circuit that compares the reference ramp signal to the analog image signal produced by the pixel sensor of the plurality of pixel sensors.

16. An image sensor according to claim 15, wherein the ADC circuit further comprises:
a counter circuit that produces a counter output signal; and
a latch circuit that latches the counter output responsive to an output signal produced by the comparator circuit.

17. An image sensor according to claim 11, wherein the plurality of pixel sensors comprises a first color pixel sensor in a first row and a second color pixel sensor in a second row, wherein the first and second color pixel sensors are coupled to the same image data line, wherein the ADC circuit is coupled to the image data line and produces a digital output signal from an analog image signal on the image data line subject to an offset controlled by the offset control signal, and wherein the dark level compensation circuit generates respective first and second offset control signals to apply for the respective first and second color pixel sensors and selectively applies the first and second offset signals to the ADC circuit.

18. An image sensor according to claim 11, wherein the plurality of pixel sensors comprises a plurality of CMOS pixel sensors.

19. A method of operating an image sensor, comprising:
generating dark pixel image signals from dark pixel sensors on multiple rows of a CMOS pixel sensor array;
generating an offset control signal from the dark pixel image signals;
producing an image signal from a pixel sensor of the CMOS pixel sensor array; and
applying an offset to the image signal responsive to the offset control signal.

20. A method according to claim 19, wherein generating an offset control signal comprises:
generating a mean dark level signal from the dark pixel image signals; and
generating the offset control signal from a comparison of the mean dark level signal to a target dark level signal.

21. A method according to claim 19, wherein applying an offset to the image signal comprises varying an offset applied in an analog to digital converter (ADC) circuit responsive to the offset control signal.

22. A method according to claim 21, wherein varying an offset applied in an ADC circuit comprises varying an offset of a reference signal.

23. A method of operating an image sensor comprising a plurality of pixel sensors, the method comprising:
generating dark pixel image signals from a plurality of dark pixel sensors included in the plurality of pixel sensors;
generating an offset control signal from the dark pixel image signals;
applying the offset control signal to an analog to digital converter (ADC) circuit that receives an analog image signal produced by a pixel sensor of the plurality of pixel sensors to produce a dark level compensated digital image signal.

24. A method according to claim 23, wherein applying the offset control signal to an analog to digital converter (ADC) circuit that receives an analog image signal produced by a pixel sensor of the plurality of pixel sensors to produce a dark level compensated digital image signal comprises:
varying an offset of a reference signal responsive to the offset control signal; and
comparing the analog image signal produced by the pixel sensor to the reference signal to generate a dark level compensated digital image signal.

25. A method according to claim 23, wherein the plurality of pixel sensors comprises a plurality of CMOS pixel sensors.
